(19) United States
(12) Patent Application Publication
(10) Pub. No.: US 2025/0206219 A1
(43) Pub. Date: Jun. 26, 2025

(54) BOAT CENTERING KITS, BOAT CENTERING SYSTEMS, AND METHODS OF USING THE LIKE

(71) Applicant: BoatHugger LLC, Gibsonburg, OH (US)

(72) Inventor: Robert Michael Reiss, Gibsonburg, OH (US)

(73) Assignee: BoatHugger LLC, Gibsonburg, OH (US)

(21) Appl. No.: 18/979,834

(22) Filed: Dec. 13, 2024

Related U.S. Application Data
(60) Provisional application No. 63/612,615, filed on Dec. 20, 2023.

(51) Int. Cl. B60P 3/10

(52) U.S. Cl. CPC B60P 3/1075; B60P 3/1066

(57) ABSTRACT

Boat centering kits, boat centering systems, and methods of the like are described. An example boat centering kit has a first support member, a first pivot, a first alignment member, a second alignment member, a second support member, a second pivot, a third alignment member, and a fourth alignment member. The first pivot is attachable to the first support member and the second pivot is attachable to the second support member. The first alignment member and the second alignment member are attachable to the first support member. The third alignment member and the fourth alignment member are attachable to the second support member.

### FIELD

The disclosure relates to the field of boat centering kits, boat centering systems, and methods of using the like.

### BACKGROUND

Navigating a boat trailer into the water for retrieving a vessel can be a challenging task, requiring precision and control. Boat owners often face difficulties aligning their boats with the trailer, especially in adverse weather conditions such as strong currents, high winds, or limited visibility.

A need exists, therefore, for improved boat centering kits, boat centering systems, and methods of using the like.

### BRIEF SUMMARY OF SELECTED EXAMPLES

Various example boat centering kits, boat centering systems, and methods of using the like are described.

An example boat centering kit for attachment to a boat trailer has a first support member, a first pivot, a first alignment member, a second alignment member, a second support member, a second pivot, a third alignment member, and a fourth alignment member. The first pivot is attachable to the first support member and the second pivot is attachable to the second support member. The first alignment member and the second alignment member are attachable to the first support member. The third alignment member and the fourth alignment member are attachable to the second support member.

Additional understanding of the inventive boat centering kits, boat centering systems, and methods of using the like can be obtained by reviewing the detailed description of selected examples, below, and the referenced drawings.

### DESCRIPTION OF FIGURES

FIG. 1 is a partially exploded view of a first example boat centering kit.

FIG. 2 is a partially exploded view of a second example boat centering kit.

FIG. 3 is a partial perspective view of an example boat centering system attached to a trailer. A boat is illustrated positioned on the trailer.

FIG. 4 is another partial perspective view of the boat centering system shown in FIG. 3.

FIG. 5 is a partial perspective view of a first support member of the boat centering system shown in FIG. 3.

FIG. 6 is another partial perspective view of the first support member shown in FIG. 5.

FIG. 7 is a partial perspective view of a first pivot of the boat centering system shown in FIG. 3.

FIG. 8 is a partial perspective view of a second pivot of the boat centering system shown in FIG. 3.

FIG. 9 is a top view of a boat being positioned on the boat centering system shown in FIG. 3. The boat is illustrated contacting a second alignment member of the boat centering system.

FIG. 10 is another top view of the boat and boat centering system shown in FIG. 9. The boat is illustrated contacting a third alignment member of the boat centering system after contacting the second alignment member.

FIG. 11 is another top view of the boat and boat centering system shown in FIG. 9 after the boat centering system has assisted with aligning the boat on the trailer.

FIG. 12 is a partial perspective view of a portion of the second example boat centering kit shown in FIG. 2.

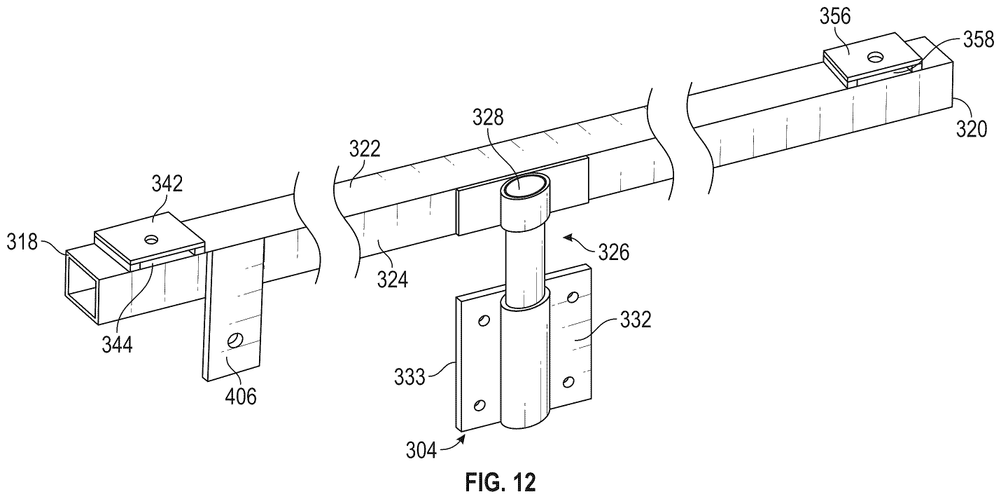

FIG. 13 is a partially exploded view of a portion of a third example boat centering kit.

### DETAILED DESCRIPTION OF SELECTED EXAMPLES

The following detailed description and the appended drawings describe and illustrate various example boat centering kits, boat centering systems, and methods of using the like. The description and illustration of these examples enable one skilled in the art to make and use a boat centering kit, a boat centering system, and to practice a method of using a boat centering kit or a boat centering system. They are not intended to limit the scope of the claims in any manner. The invention is capable of being practiced or carried out in various ways and the examples described and illustrated herein are merely selected examples of the various ways of practicing or carrying out the invention and are not considered exhaustive.

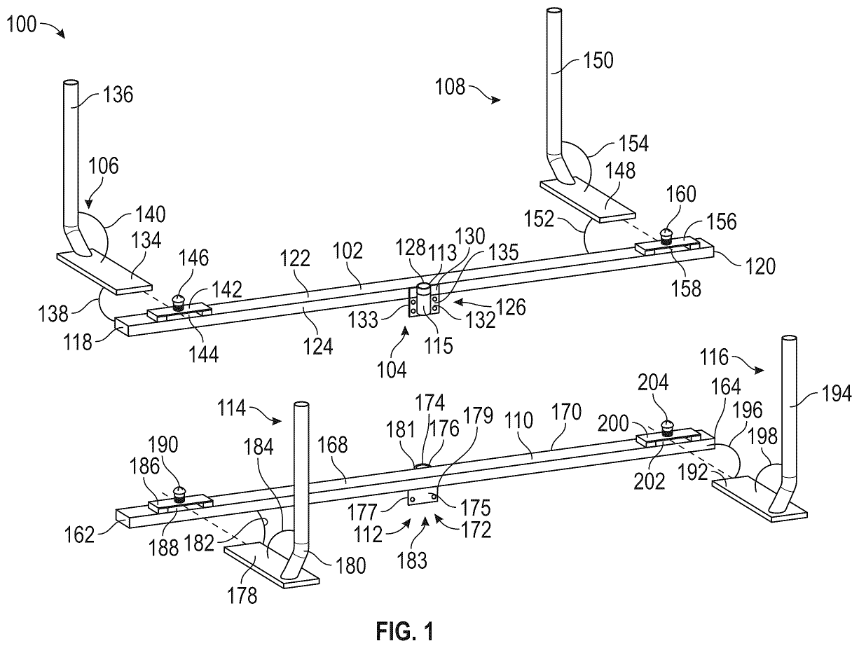

FIG. 1 illustrates a first example boat centering kit 100. The boat centering kit 100 is attachable to a boat trailer to assist with aligning a boat on the boat trailer, as described in more detail herein. The boat centering kit 100 has a first support member 102, a first pivot 104, a first alignment member 106, a second alignment member 108, a second support member 110, a second pivot 112, a third alignment member 114, and a fourth alignment member 116.

The first support member 102 has a first support member first end 118, a first support member second end 120, a first support member first surface 122, and a first support member second surface 124. The first support member first surface 122 is relatively perpendicular to the first support member second surface 124. The first support member 102 extends from the first support member first end 118 to the first support member second end 120. While the first support member 102 has been illustrated as having a particular structural configuration and has having a first support member first surface 122 and a first support member second surface 124, a first support member can have any suitable structural arrangement and have any suitable number of surfaces.

The first pivot 104 is attachable to a boat trailer (e.g., configured to be attached to a boat trailer) and is attachable to the first support member 102 between the first support member first end 118 and the first support member second end 120. The first pivot 112 is attachable at a point on the trailer that is central to where the bottom of a boat is designed to rest. In the illustrated embodiment, the first pivot 104 has a first pivot mount 126 and a first pivot pin 128. The first pivot mount 126 has a first pivot mount first portion 130 and a first pivot mount second portion 132. The first pivot mount first portion 130 and the first pivot mount second portion 132 can be any desired size. For example, a pivot mount second portion can have dimensions equal to about 15.24 cm (6 in.)×15.24 cm (6 in) and include a 1.5 in×6 in tube. In addition, a pivot mount first portion can have dimensions equal to about 5.08 cm (2 in)×15.24 cm (6 in) and include a 1.5 in×2 in tube. The first pivot mount first portion 130 is attachable to the first support member 102. In the illustrated embodiment, the first pivot mount first portion 130 is attached (e.g., welded) to the first support member second surface 124. In the embodiment shown, the first pivot 104 is relatively centered between the first support member first end 118 and the first support member second end 120. However, a first pivot does not have to be centered relative to a first support member first end and a first support member second end. For example, a first pivot could alternatively be positioned closer to a first support member first end or a first support member second end. The first pivot mount second portion 132 is attachable to a boat trailer (e.g., configured to be attached to the boat trailer). In the illustrated embodiment, the first pivot mount second portion 132 includes a first bracket 133 and a second bracket 135. The first and second brackets 133, 135 can be attached to a boat trailer using U-bolts, or any other means of attachment. For example, a bolt or a series of bolts can be used to attach a first pivot a to a trailer.

In the illustrated embodiment, the first alignment member 106 has a first alignment member first portion 134 and a first alignment member second portion 136. The first alignment member first portion 134 extends from the first support member 102 at a first alignment member first portion angle 138 when the first alignment member 106 is attached to the first support member 102. The first alignment member first portion angle 138 is greater than 0 degrees and less than 180 degrees. The first alignment member second portion 136 extends from the first alignment member first portion 134 at a first alignment member second portion angle 140 relative to the first alignment member first portion 134. The first alignment member second portion angle 140 is greater than 0 degrees and less than 180 degrees. The first alignment member 106 is attachable to the first support member 102 between the first pivot 104 and the first support member first end 118. A first connector 142 is attached to the first support member 102 (e.g., first support member first surface 122) between the first pivot 104 and the first support member first end 118. The first connector 142 is configured to attach the first alignment member 106 to the first support member 102. The first connector 142 defines a first connector passageway 144 through which the first alignment member 106 (e.g., first alignment member first portion 134) can be passed. The boat centering kit 100 further includes a first fastener 146 disposed in the first connector passageway 144. The first fastener 146 is configured to adjustably secure the first alignment member 106 to the first support member 102. However, the first alignment member 106 does not have to be configured to be adjustably secured to the first support member 102. In alternative embodiments, a first alignment member first portion can instead be secured directly to a first support member by any desired means such as, but not limited to, welding, bolting, etc.

In the illustrated embodiment, the second alignment member 108 has a second alignment member first portion 148 and a second alignment member second portion 150. The second alignment member first portion 148 extends from the first support member 102 at a second alignment member first portion angle 152 when the second alignment member 108 is attached to the first support member 102. The second alignment member first portion angle 152 is greater than 0 degrees and less than 180 degrees. The second alignment member second portion 150 extends from the second alignment member first portion 148 at a second alignment member second portion angle 154 relative to the second alignment member first portion 148. The second alignment member second portion angle 154 is greater than 0 degrees and less than 180 degrees. The second alignment member 108 is attachable to the first support member 102 between the first pivot 104 and the first support member second end 120. A second connector 156 is attached to the first support member 102 (e.g., first support member first surface 122) between the first pivot 104 and the first support member second end 120. The second connector 156 is configured to attach the second alignment member 108 to the first support member 102. The first connector 142 defines a second connector passageway 158 through which the second alignment member 108 (e.g., second alignment member first portion 148) can be passed. The boat centering kit 100 further includes a second fastener 160 disposed in the second connector passageway 158. The second fastener 160 is configured to adjustably secure the second alignment member 108 to the second support member 110. However, the second alignment member 108 does not have to be configured to be adjustably secured to the first support member 102. In alternative embodiments, a second alignment member first portion can instead be secured directly to the first support member by any desired means such as, but not limited to, welding, bolting, etc.

In the embodiment illustrated, the second support member 110 has a second support member first end 162, a second support member second end 164, a second support member first surface 168, and a second support member second surface 170. The second support member first surface 168 is relatively perpendicular to the second support member second surface 170. The second support member 110 extends from the second support member first end 162 to the second support member second end 164. While the second support member 110 has been illustrated as having a particular structural configuration and has having a second support member first surface 168 and a second support member second surface 170, a second support member can have any suitable structural arrangement and have any suitable number of surfaces. Each of the first support member 102 and the second support member 110 can have any dimensions, such as those equal to about 5.08 (2 in)×5.08 (2 in) and a length of between about 2.4384 (8 ft) and about 3.048 (10 ft), or any other size depending on the type of boat that is intended to be trailered.

The second pivot 112 is attachable to a boat trailer (e.g., configured to be attached to a boat trailer) and is attachable to the second support member 110 between the second support member first end 162 and the second support member second end 164. The second pivot 112 is attachable at a point on the trailer that is central to where the bottom of a boat is designed to rest. In the illustrated embodiment, the second pivot 112 has a second pivot mount 172 and a second pivot pin 174. The second pivot mount 172 has a second pivot mount first portion 176 and a second pivot mount second portion 175, which are identical to the first pivot mount first portion 130 and the first pivot mount second portion 132. The second pivot mount first portion 176 is attachable to the second support member 110. In the embodiment shown, the second pivot mount first portion 176 is attached (e.g., welded) to the second support member second surface 170. In the illustrated embodiment, the second pivot 112 is relatively centered between the second support member first end 162 and the second support member second end 164. However, a second pivot does not have to be centered relative to a second support member first end and a second support member second end. For example, a second pivot could alternatively be positioned closer to a second support member first end or a second support member second end. The second pivot mount second portion 175 is attachable to a boat trailer (e.g., configured to be attached to the boat trailer). In the illustrated embodiment, the second pivot mount second portion 175 includes a first bracket 177 and a second bracket 179. The first and second brackets 177, 179 can be attached to the boat trailer using U-bolts, or any other means of attachment. For example, a bolt or a series of bolts can be used to attach a second pivot to a trailer.

In the illustrated embodiment, the third alignment member 114 has a third alignment member first portion 178 and a third alignment member second portion 180. The third alignment member first portion 178 extends from the second support member 110 at a third alignment member first portion angle 182 when the third alignment member 114 is attached to the second support member 110. The third alignment member first portion angle 182 is greater than 0 degrees and less than 180 degrees. The third alignment member second portion 180 extends from the third alignment member first portion 178 at a third alignment member second portion angle 184 relative to the third alignment member first portion 178. The third alignment member second portion angle 184 is greater than 0 degrees and less than 180 degrees. The third alignment member 114 is attachable to the second support member 110 between the second pivot 112 and the second support member first end 162. A third connector 186 is attached to the second support member 110 (e.g., second support member first surface 168) between the second pivot 112 and the second support member first end 162. The third connector 186 is configured to attach the third alignment member 114 to the second support member 110. The third connector 186 defines a third connector passageway 188 through which the third alignment member 114 (e.g., third alignment member first portion 178) can be passed. The boat centering kit 100 further includes a third fastener 190 disposed in the third connector passageway 188. The third fastener 190 is configured to adjustably secure the third alignment member 114 to the second support member 110. However, the third alignment member 114 does not have to be configured to be adjustably secured to the second support member 110. In alternative embodiments, a third alignment member first portion can instead be secured directly to a second support member by any desired means such as, but not limited to, welding, bolting, etc.

In the illustrated embodiment, the fourth alignment member 116 has a fourth alignment member first portion 192 and a fourth alignment member second portion 194. The fourth alignment member first portion 192 extends from the second support member 110 at a fourth alignment member first portion angle 196 when the fourth alignment member 116 is attached to the second support member 110. The fourth alignment member first portion angle 196 is greater than 0 degrees and less than 180 degrees. The fourth alignment member second portion 194 extends from the fourth alignment member first portion 192 at a fourth alignment member second portion angle 198 relative to the fourth alignment member first portion 192. The fourth alignment member second portion angle 198 is greater than 0 degrees and less than 180 degrees. The fourth alignment member 116 is attachable to the second support member 110 between the second pivot 112 and the second support member second end 164. A fourth connector 200 is attached to the second support member 110 (e.g., second support member first surface 168) between the second pivot 112 and the second support member second end 164. The fourth connector 200 is configured to attach the fourth alignment member 116 to the second support member 110. The fourth connector 200 defines a fourth connector passageway 202 through which the fourth alignment member 116 (e.g., fourth alignment member first portion 192) can be passed. The boat centering kit 100 further includes a fourth fastener 204 disposed in the fourth connector passageway 202. The fourth fastener 204 is configured to adjustably secure the fourth alignment member 116 to the second support member 110. However, the fourth alignment member 116 does not have to be configured to be adjustably secured to the second support member 110. In alternative embodiments, a fourth alignment member first portion can instead be secured directly to a second support member by any desired means such as, but not limited to, welding, bolting, etc.

Further, each of the first alignment member first portion 134, the second alignment member first portion 148, the third alignment member first portion 178, and the fourth alignment member first portion 192 can have any suitable dimensions, such as those that are equal to about 6.35 cm (2.5 in)×27.94 cm (11 in)×0.9525 cm (⅜ in). The first alignment member second portion 136, the second alignment member second portion 150, the third alignment member second portion 180, and the fourth alignment member second portion 194 can also be any desired dimensions, such as those that are equal to about 3.81 cm (1.5 in) in diameter and a height of about 1.524 m (5 ft).

Each of the first alignment member first portion angle 138, the first alignment member second portion angle 140, the second alignment member first portion angle 152, the second alignment member second portion angle 154, the third alignment member first portion angle 182, the third alignment member second portion angle 184, the fourth alignment member first portion angle 196, and the fourth alignment member second portion angle 198 can be greater than about 45 degrees. In the illustrated embodiment, the first alignment member first portion angle 138, the second alignment member first portion angle 152, the third alignment member first portion angle 182, and the fourth alignment member portion angle are substantially equal to 90 degrees. Also, the first alignment member second portion angle 140, the second alignment member second portion angle 154, the third alignment member second portion angle 184, and the fourth alignment member second portion 194 are greater than approximately 90 degrees. Although particular angles are described, any suitable angle can be used depending on the size and shape of the boat that is being trailered and/or the structural arrangement of the materials used to form the components of a kit. Although not illustrated in FIG. 1, a first shield can be disposed over the first alignment member second portion 136, a second shield can be disposed over the second alignment member second portion 150, a third shield can be disposed over the third alignment member second portion 180, and a fourth shield can be disposed over the fourth alignment member second portion 194. A shield included in a kit can include one or more pieces of foam covered with a canvas sleeve and formed to entirely, or partially, surround the outer surfaces of an alignment member. Any suitable shield can be included in a kit, such as trailer guide pads, and any other shield considered suitable for a particular embodiment.

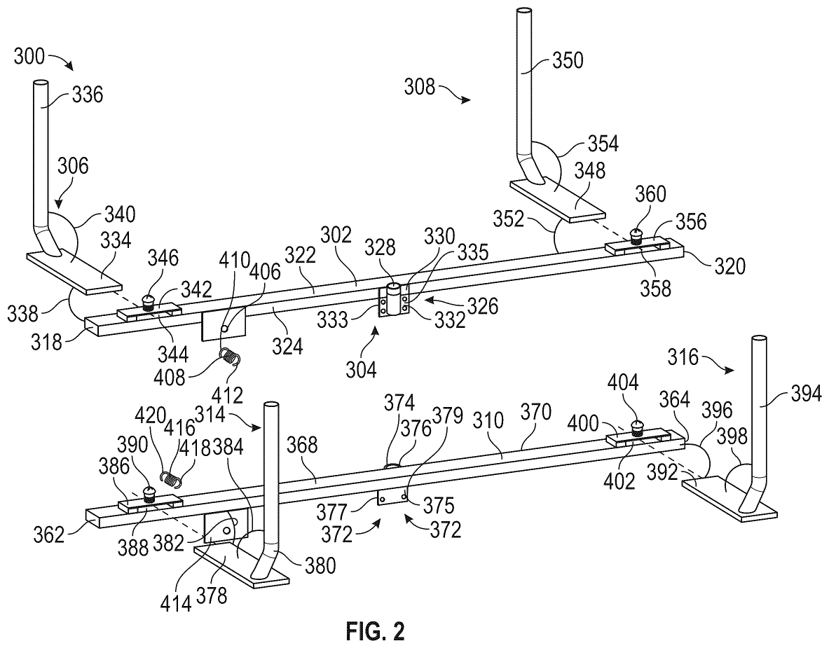

FIG. 2 illustrates a second example boat centering kit 300. The boat centering kit 300 is similar to the boat centering kit 100 illustrated in FIG. 1 and described above, except as detailed below.

The boat centering kit 300 is attachable to a boat trailer to assist with aligning a boat on the boat trailer, as described in more detail herein. The boat centering kit 300 has a first support member 302, a first pivot 304, a first alignment member 306, a second alignment member 308, a second support member 310, a second pivot 312, a third alignment member 314, and a fourth alignment member 316.

The first support member 302 has a first support member first end 318, a first support member second end 320, a first support member first surface 322, and a first support member second surface 324. The first support member first surface 322 is relatively perpendicular to the first support member second surface 324. The first support member 302 extends from the first support member first end 318 to the first support member second end 320.

The first pivot 304 is attachable to a boat trailer (e.g., configured to be attached to a boat trailer) and is attachable to the first support member 302 between the first support member first end 318 and the first support member second end 320. In the illustrated embodiment, the first pivot 304 has a first pivot mount 326 and a first pivot pin 328. The first pivot mount 326 has a first pivot mount first portion 330 and a first pivot mount second portion 332. The first pivot mount first portion 130 is attachable to the first support member 302. In the illustrated embodiment, the first pivot mount first portion is attached (e.g., welded) to the first support member second surface 324. In the embodiment shown, the first pivot 304 is relatively centered between the first support member first end 318 and the first support member second end 320. In the illustrated embodiment, the first pivot mount second portion 332 includes a first bracket 333 and a second bracket 335. The first and second brackets 333, 335 can be attached to a boat trailer using U-bolts, or any other means of attachment. For example, a bolt or a series of bolts can be used to attach a first pivot a to a trailer.

In the embodiment shown, the boat centering kit 300 includes a first stopping member 406 and a first spring 408. The first stopping member 406 is attached to the first support member 302 (e.g., first support member second surface 324) between the first pivot 304 and the first support member second end 320. The first stopping member 406 extends away from the first support member 302 (e.g., first support member first surface 322). The first spring 408 has a first spring first end 410 and a first spring second end 412. The first spring first end 410 is attachable to the first stopping member 406 and the first spring second end 412 is attachable to a boat trailer. A stopping member can have any suitable dimensions, such as those equal to about 2.5 in×6 in.

In the illustrated embodiment, the first alignment member 306 has a first alignment member first portion 348 and a first alignment member second portion 336. The first alignment member first portion 348 extends from the first support member 302 at a first alignment member first portion angle 338 when the first alignment member 306 is attached to the first support member 302. The first alignment member second portion 336 extends from the first alignment member first portion 334 at a first alignment member second portion angle 340 relative to the first alignment member first portion 334. The first alignment member 306 is attachable to the first support member 302 between the first pivot 304 and the first support member first end 318 using the first connector 342 and the first fastener 346 disposed in the first connector passageway 344.

As shown, the second alignment member 308 has a second alignment member first portion 348 and a second alignment member second portion 350. The second alignment member first portion 348 extends from the first support member 302 at a second alignment member first portion angle 352 when the second alignment member 308 is attached to the first support member 302. The second alignment member second portion 350 extends from the second alignment member first portion 348 at a second alignment member second portion angle 354 relative to the second alignment member first portion 350. The second alignment member 308 is attachable to the first support member 302 between the first pivot 304 and the first support member second end 320 using the second connector 356 and the second fastener 360 disposed in the second connector passageway 358.

The second support member 310 has a second support member first end 362, a second support member second end 364, a second support member first surface 366, and a second support member second surface 370. The second support member first surface 366 is relatively perpendicular to the second support member second surface 370. The second support member 310 extends from the second support member first end 362 to the second support member second end 364.

The second pivot 312 is attachable to a boat trailer (e.g., configured to be attached to a boat trailer) and is attachable to the second support member 310 between the second support member first end 362 and the second support member second end 364. In the illustrated embodiment, the second pivot 312 has a second pivot mount 372 and a second pivot pin 374. The second pivot mount 372 has a second pivot mount first portion 376 and a second pivot mount second portion 375. The second pivot mount first portion 376 is attachable to the second support member 310. In the embodiment shown, the second pivot mount first portion 376 is attached (e.g., welded) to the second support member second surface 364. The second pivot 312 is relatively centered between the second support member first end 362 and the second support member second end 364. The second pivot mount second portion 375 includes a first bracket 377 and a second bracket 379. The first and second brackets 377, 379 can be attached to a boat trailer using U-bolts, or any other means of attachment. For example, a bolt or a series of bolts can be used to attach a first pivot a to a trailer.

In the embodiment shown, the boat centering kit 300 includes a second stopping member 414 and a second spring 416. The second stopping member 414 is attached to the second support member 310 (e.g., second support member second surface 370) between the second pivot 312 and the second support member second end 364. The second stopping member 414 extends away from the second support member 310 (e.g., second support member first surface 366). The second spring 416 has a second spring first end 418 and a second spring second end 420. The second spring first end 418 is attachable to the second stopping member 414 and the second spring second end 420 is attachable to a boat trailer. The first stopping member 406 and the second stopping member 414 can each have a hole therethrough that is configured to receive a bolt. A nut can then be attached to said bolt, preventing the bolt from becoming free of the hole. The bolt can be used to adjust the position of the alignment members 306, 308, 314, 316 so that they are tight against the boat when it is trailered. The bolt also provides a mechanism to align the alignment members 306, 308, 314, 316 with the trailer. Since no boat or tailer is the same, inclusion of a bolt allows for customization for the stopping point of each of the pivots 304, 312.

In the illustrated embodiment, the third alignment member 314 has a third alignment member first portion 378 and a third alignment member second portion 380. The third alignment member first portion 378 extends from the second support member 310 at a third alignment member first portion angle 382 when the third alignment member 314 is attached to the second support member 310. The third alignment member second portion 380 extends from the third alignment member first portion 378 at a third alignment member second portion angle 384 relative to the third alignment member first portion 378. The third alignment member 314 is attachable to the second support member 310 between the second pivot 312 and the second support member first end 362 using the third connector 386 and the third fastener 390 disposed in the third connector passageway 388.

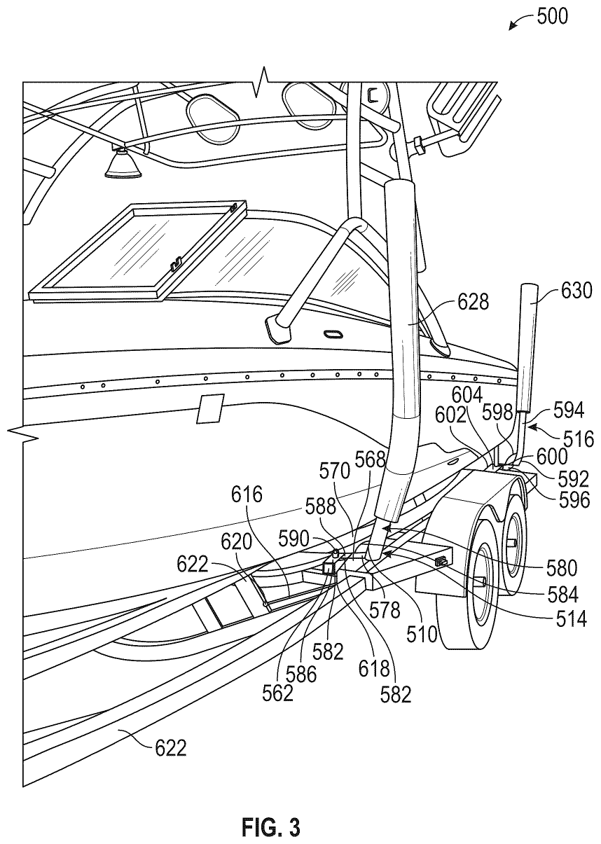

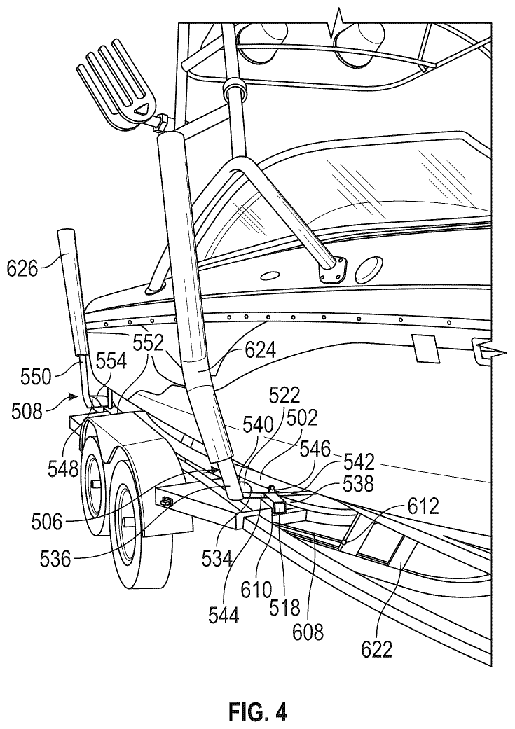

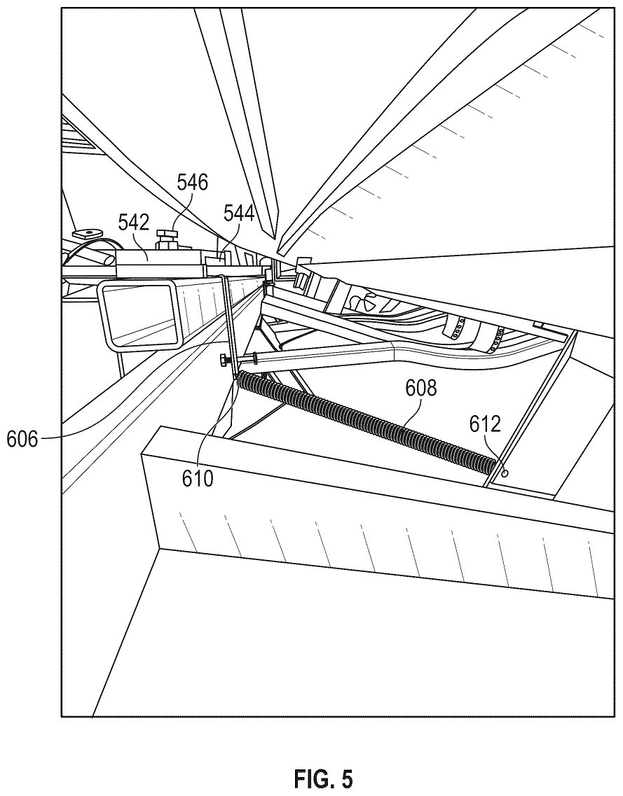

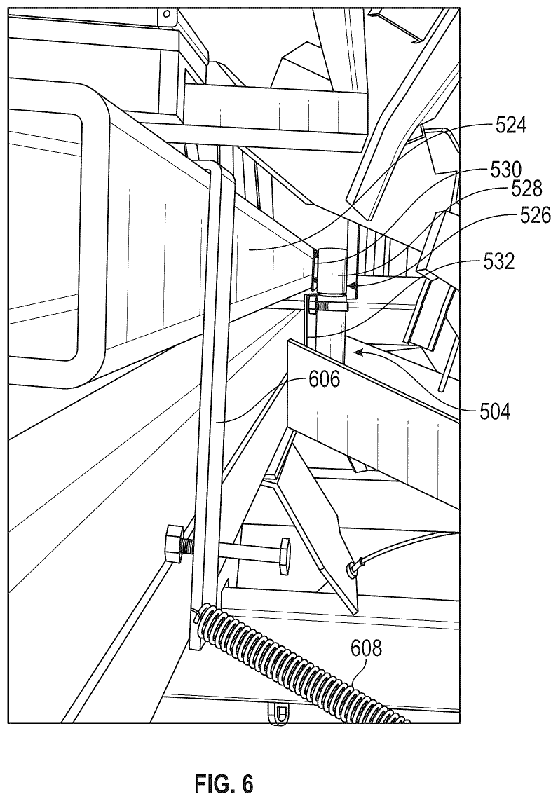

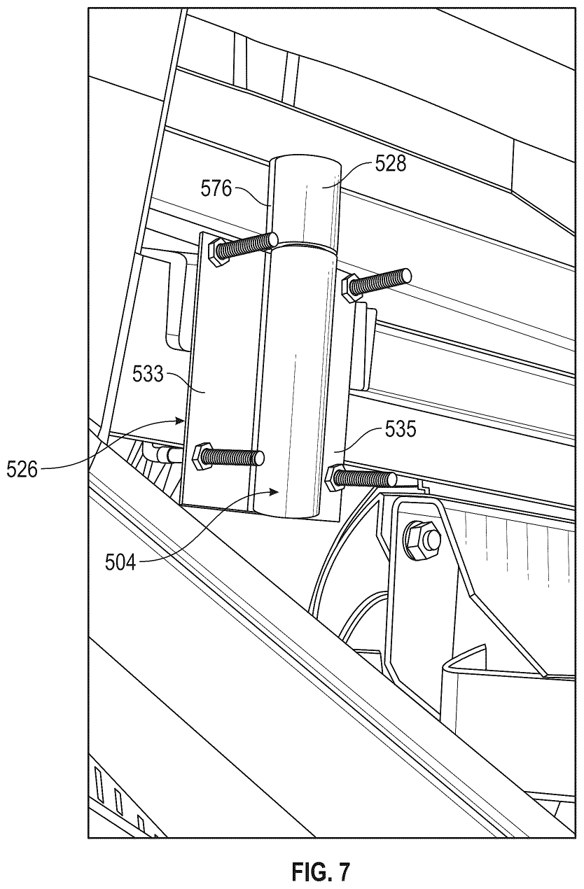

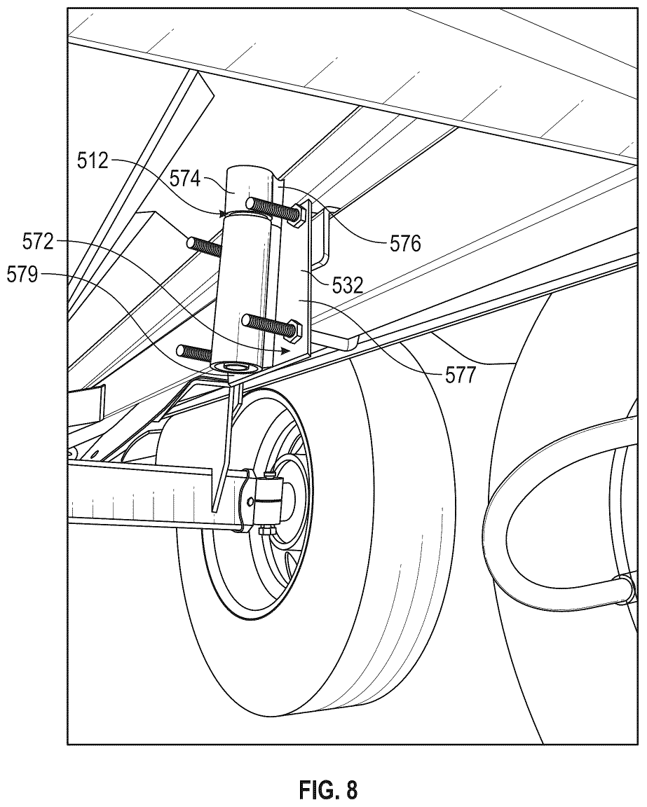

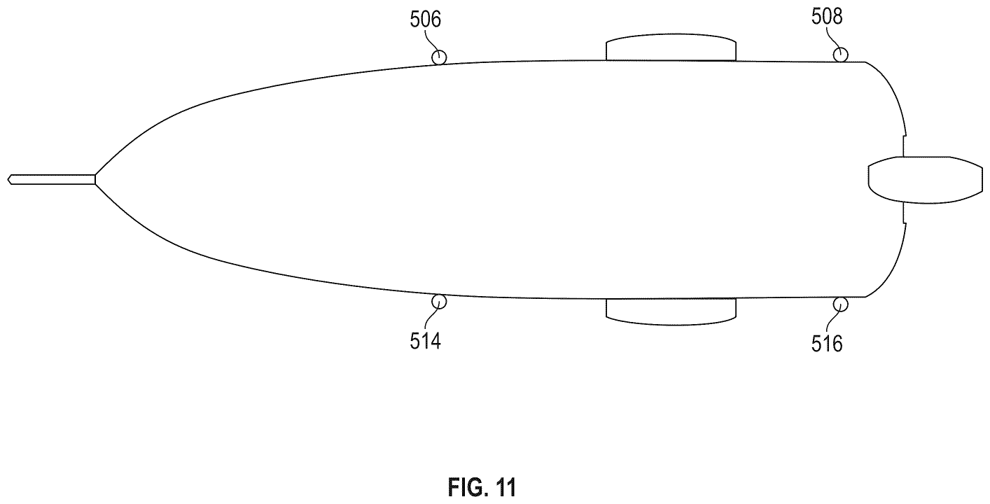

As shown, the fourth alignment member 316 has a fourth alignment member first portion 392 and a fourth alignment member second portion 394. The fourth alignment member first portion 392 extends from the second support member 310 at a fourth alignment member first portion angle 396 when the fourth alignment member 316 is attached to the second support member 310. The fourth alignment member second portion 394 extends from the fourth alignment member first portion 392 at a fourth alignment member second portion angle 398 relative to the fourth alignment member first portion 392. The fourth alignment member 316 is attachable to the second support member 310 between the second pivot 312 and the second support member second end 320 using the fourth connector 400 and the fourth fastener 404 disposed in the fourth connector passageway 402. Each of FIGS. 3, 4, 5, 6, 7, 8, 9, 10, and 11 illustrates an example boat centering system 500. The boat centering system 500 includes boat centering kit 300, as described above relative to FIG. 2. The boat centering kit 300 has a first support member 502, a first pivot 504, a first alignment member 506, a second alignment member 508, a second support member 510, a second pivot 512, a third alignment member 514, a fourth alignment member 516, a first stopping member 606, a first spring 608, a second stopping member 614, and a second spring 616.

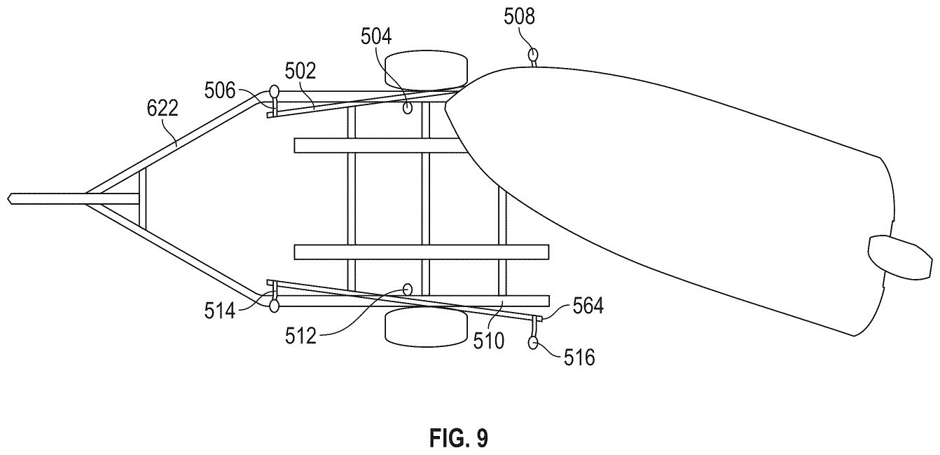

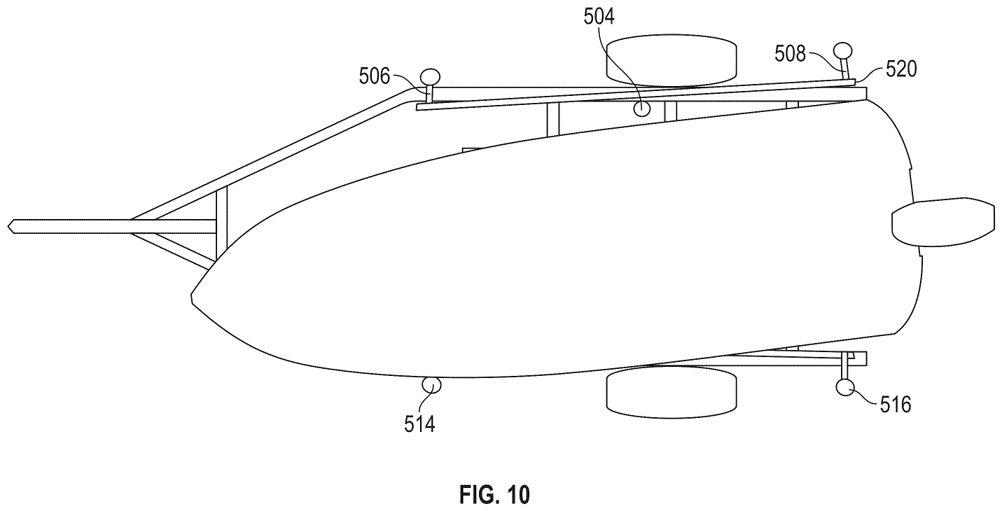

The first support member 502 has a first support member first end 518 a first support member second end 520, a first support member first surface 522, and a first support member second surface 524. The first pivot 504 is attached to the boat trailer 622 and has a first pivot mount 526 and a first pivot pin 528. The first pivot mount 526 has a first pivot mount first portion 530 and a first pivot mount second portion 632 that is attached to the boat trailer 622. The first pivot 504 is connected to the boat trailer 622 by a first bracket 533 and a second bracket 535 using U-bolts. The first stopping member 606 is attached to a first support member second surface 524 between the first pivot 504 and the first support member second end 520. The first stopping member 606 extends away from the first support member first surface 522. The first spring 608 has a first spring first end 610 and a first spring second end 612. The first spring first end 610 is attached to the first stopping member 606 and the first spring second end 612 is attached to the boat trailer 622. The first spring 608 biases the first support member first end 518 toward the center of the boat trailer 622, as shown in FIGS. 9 and 10.

The first alignment member 506 has a first alignment member first portion 534 and a first alignment member second portion 536. The first alignment member first portion 534 extends from the first support member 502 at a first alignment member first portion angle 552 when the first alignment member 506 is attached to the first support member 502. The first alignment member second portion 536 extends from the first alignment member first portion 534 at a first alignment member second portion angle 554 relative to the first alignment member first portion 534. The first alignment member 506 is attached to the first support member 502 between the first pivot 504 and the first support member first end 518 using the first connector 542 and the first fastener 546 disposed in the first connector passageway 544.

In the illustrated embodiment, the second alignment member 508 has a second alignment member first portion 548 and a second alignment member second portion 550. The second alignment member first portion 548 extends from the first support member 502 at a second alignment member first portion angle 552 when the second alignment member 508 is attached to the first support member 502. The second alignment member second portion 550 extends from the second alignment member first portion 548 at a second alignment member second portion angle 554 relative to the second alignment member first portion 548. The second alignment member 508 is attached to the first support member 502 between the first pivot 504 and the first support member second end 520 using the second connector 556 and the second fastener 560 disposed in the second connector passageway 558.

The second support member 510 has a second support member first end 562, a second support member second end 564, a second support member first surface 568, and a second support member second surface 570. The second pivot 512 is attached to the boat trailer 622 and has a second pivot mount 572 and a second pivot pin 574. The second pivot mount 572 has a second pivot mount first portion 576 and a second pivot mount second portion 575 that is attached to the boat trailer 622. The second pivot 512 is connected to the boat trailer 622 by a first bracket 577 and a second bracket 579 using U-bolts. The second stopping member 614 is attached to a second support member second surface 570 between the second pivot 512 and the second support member second end 564. The second stopping member 614 extends away from the second support member first surface 568. The second spring 616 has a second spring first end 618 and a second spring second end 620. The second spring first end 618 is attached to the second stopping member 614 and the second spring second end 620 is attached to the boat trailer 622. The second spring 616 biases the second support member first end 562 toward the center of the boat trailer 622, as shown in FIGS. 9 and 10.

In the illustrated embodiment, the third alignment member 514 has a third alignment member first portion 578 and a third alignment member second portion 580. The third alignment member first portion 578 extends from the second support member 510 at a third alignment member first portion angle 582 when the third alignment member 514 is attached to the second support member 510. The third alignment member second portion 580 extends from the third alignment member first portion 578 at a third alignment member second portion angle 584 relative to the third alignment member first portion 578. The third alignment member 514 is attached to the second support member 510 between the second pivot 512 and the second support member first end 562 using the third connector 586 and the third fastener 590 disposed in the third connector passageway 588.

In the illustrated embodiment, the fourth alignment member 516 has a fourth alignment member first portion 592 and a fourth alignment member second portion 594. The fourth alignment member first portion 592 extends from the second support member 510 at a fourth alignment member first portion angle 596 when the fourth alignment member 516 is attached to the second support member 510. The fourth alignment member second portion 594 extends from the fourth alignment member first portion 592 at a fourth alignment member second portion angle 598 relative to the fourth alignment member first portion 592. The fourth alignment member 516 is attached to the second support member 510 between the second pivot 512 and the second support member second end 564 using the fourth connector 600 and the fourth fastener 604 disposed in the fourth connector passageway 602. In the illustrated embodiment, a first shield 624 is disposed over the first alignment member second portion 536, a second shield 626 is disposed over the second alignment member second portion 550, a third shield 628 is disposed over the third alignment member second portion 580, and a fourth shield 630 is disposed over the fourth alignment member second portion 594.

Each of FIGS. 9, 10, and 11 shows a different step of using the boat centering system 500 to align the boat on a trailer 622. When an individual is ready to load their boat onto a trailer 622, the individual aims a nose of the boat somewhere between the second alignment member 508 and the fourth alignment member 516. If the boat comes in contact with the second alignment member 508, as shown in FIG. 9, the first support member 502 pivots at the first pivot 504, relative to the trailer 622, causing the second alignment member 508 to move in a direction that the boat pushes it. As the boat pushes the second alignment member 508, the first spring 608 is stretched, thus the first spring 608 applies a force opposite that the boat is applying. This causes the nose of the boat to travel in a direction opposite of the second alignment member 508. The boat then can come in contact with the third alignment member 514, as shown in FIG. 10. However, unlike the second alignment member 508, the third alignment member 514 will not move due to the second stopping member 614 coming in contact with the boat trailer 622. This process will continue to happen until the boat is loaded onto the boat trailer 622.

Alternatively, the boat can first come in contact with the fourth alignment member 516. The second support member 510 will then pivot at the second pivot 512, relative to the trailer 622, causing the fourth alignment member 516 to move in a direction that the boat pushes it. As the boat pushes the fourth alignment member 516, the second spring 616 is stretched, thus the second spring 616 applies a force opposite that the boat is applying. This causes the nose of the boat to travel in a direction opposite of the fourth alignment member 516. The boat then can come in contact with the first alignment member 506. However, unlike the fourth alignment member 516, the first alignment member 506 will not move due to the first stopping member 606 coming in contact with the boat trailer 622. This process will continue to happen until the boat is loaded onto the boat trailer 622.

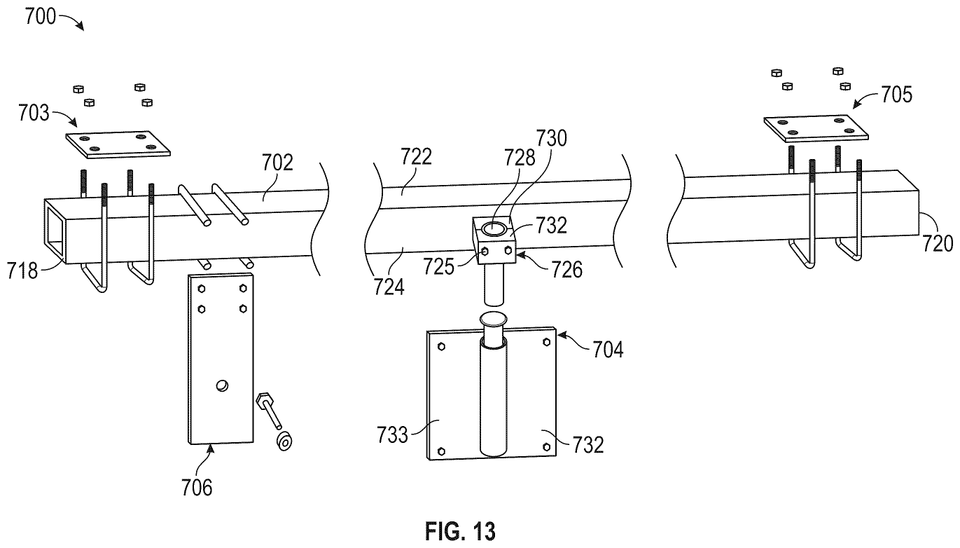

FIG. 13 illustrates a portion of a third example boat centering kit 700. The boat centering kit 700 is similar to the boat centering kit 300 illustrated in FIG. 2 and described above, except as detailed below.

The boat centering kit 700 is attachable to a boat trailer to assist with aligning a boat on the boat trailer, as described in more detail herein. The boat centering kit 700 has a first support member 702 and a second support member (not illustrated.) The first support member 702 has a first pivot 704, a first alignment member (not illustrated), a second alignment member (not illustrated), a second support member (not illustrated), a second pivot (not illustrated), a third alignment member (not illustrated), and a fourth alignment member (not illustrated).

The first support member 702 has a first support member first end 718, a first support member second end 720, a first support member first surface 722, and a first support member second surface 724. The first support member 702 extends from the first support member first end 718 to the first support member second end 720.

The first pivot 704 is attachable to a boat trailer (e.g., configured to be attached to a boat trailer) and is attachable to the first support member 702 between the first support member first end 718 and the first support member second end 720. In the illustrated embodiment, the first pivot 704 has a first pivot mount 726 and a first pivot pin 728. The first pivot mount 726 has a first pivot mount first portion 730 and a first pivot mount second portion 732. The first pivot mount first portion 730 is attachable to the first support member 702. In the illustrated embodiment, the first pivot mount first portion 730 is attached to the first support member second surface 724 by a plurality of fasteners 725. (e.g. bolts). In the embodiment shown, the first pivot 704 is relatively centered between the first support member first end 718 and the first support member second end 720. In the illustrated embodiment, the first pivot mount second portion 732 includes a first bracket 733. The first bracket 733 can be attached to a boat trailer using U-bolts, or any other means of attachment. For example, a bolt or a series of bolts can be used to attach a first pivot 704 to a trailer.

In the embodiment shown, the boat centering kit includes 700 a first stopping member 706. The first stopping member 706 is attached to the first support member 702 (e.g., first support member second surface 724) between the first pivot 704 and the first support member second end 720. The first stopping member 706 extends away from the first support member 702 (e.g., first support member first surface 722). In the illustrated embodiment, the first stopping member 706 is attached to the first support member 702 by a fastener. (e.g., U-bolts.) A stopping member can have any suitable dimensions, such as those equal to about 2.5 in×6 in.

Although not illustrated, in the third example boat centering kit 700, each of the first alignment member and the second alignment member is attached to the first support member 702 by a first bracket and U-bolt configuration 703 and a second bracket and U-bolt configuration 705 respectively. Each of the first bracket and U-bolt configuration 703 and the second bracket and U-bolt configuration 705 is beneficial at least because it provides a secure way of attaching the first alignment member and second alignment member to the first support member 702 that will not come loose during travel. Also, each of the third alignment member and the fourth alignment member is attached to the second support member by a third bracket and fourth U-bolt configuration respectively. Each of the third bracket and U-bolt and fourth bracket and U-bolt configuration is beneficial at least because it provides a secure way of attaching the third alignment member and the fourth alignment member to the second support member that will not come loose during travel.

Those with ordinary skill in the art will appreciate that various modifications and alternatives for the described and illustrated examples can be developed in light of the overall teachings of the disclosure, and that the various elements and features of one example described and illustrated herein can be combined with various elements and features of another example without departing from the scope of the invention. Accordingly, the particular arrangement of elements disclosed herein have been selected by the inventor(s) simply to describe and illustrate examples of the invention and are not intended to limit the scope of the invention or its protection, which is to be given the full breadth of the appended claims and any and all equivalents thereof.

We claim:

1. A boat centering kit for attachment to a boat trailer, comprising:
a first support member having a first support member first end and a first support member second end;
a first pivot attachable to the first support member between the first support member first end and the first support member second end, the first pivot configured to be attached to said boat trailer;
a first alignment member attachable to the first support member between the first pivot and the first support member first end, the first alignment member having a first alignment member first portion and a first alignment member second portion, the first alignment member first portion extending from the first support member at a first alignment member first portion angle when the first alignment member is attached to the first support member, the first alignment member second portion extending from the first alignment member first portion at a first alignment member second portion angle relative to the first alignment member first portion;
a second alignment member attachable to the first support member between the first pivot and the first support member second end, the second alignment member having a second alignment member first portion and a second alignment member second portion, the second alignment member first portion extending from the first support member at a second alignment member first portion angle when the second alignment member is attached to the first support member, the second alignment member second portion extending from the second alignment member first portion at a second alignment member second portion angle relative to the second alignment member first portion;
a second support member having a second support member first end and a second support member second end;
a second pivot attachable to the second support member and disposed between the second support member first end and the second support member second end, the second pivot configured to be attached to said boat trailer;
a third alignment member attachable to the second support member between the second pivot and the second support member first end, the third alignment member having a third alignment member first portion and a third alignment member second portion, the third alignment member first portion extending from the second support member at a third alignment member first portion angle when the third alignment member is attached to the second support member, the third alignment member second portion extending from the third alignment member first portion at a third alignment member second portion angle relative to the third alignment member first portion; and
a fourth alignment member attachable to the second support member between the second pivot and the second support member second end, the fourth alignment member having a fourth alignment member first portion and a fourth alignment member second portion, the fourth alignment member first portion extending from the second support member at a fourth alignment member first portion angle when the fourth alignment member is attached to the second support member, the fourth alignment member second portion extending from the fourth alignment member first portion at a fourth alignment member second portion angle relative to the fourth alignment member first portion;
wherein each of the first alignment member first portion angle, the first alignment member second portion angle, the second alignment member first portion angle, the second alignment member second portion angle, the third alignment member first portion angle, the third alignment member second portion angle, the fourth alignment member first portion angle, and the fourth alignment member second portion angle are greater than 45 degrees.

2. The kit of claim 1, wherein each of the first alignment member first portion angle, the second alignment member first portion angle, the third alignment member first portion angle, and the fourth alignment member first portion angle are substantially equal to 90 degrees.

3. The kit of claim 1, wherein the first alignment member second portion angle, the second alignment member second portion angle, the third alignment member second portion angle, and the fourth alignment member second portion angle are greater than 90 degrees.

4. The kit of claim 1, wherein the first support member has a first support member first surface and a first support member second surface, the first support member first surface being relatively perpendicular to the first support member second surface; and
wherein the first pivot has a first pivot mount and a first pivot pin, the first pivot mount having a first pivot mount first portion attached to the first support member second surface and a first pivot mount second portion configured to be attached to said boat trailer.

5. The kit of claim 4, wherein the second support member has a second support member first surface and a second support member second surface, the second support member first surface being relatively perpendicular to the second support member second surface; and
wherein the second pivot has a second pivot mount and a second pivot pin, the second pivot mount having a second pivot mount first portion attached to the second support member second surface and a second pivot mount second portion configured to be attached to said boat trailer.

6. The kit of claim 5, further comprising a first stopping member attached to a first support member second surface between the first pivot and the first support member second end and extending away from the first support member first surface.

7. The kit of claim 6, further comprising a first spring having a first spring first end and a first spring second end, the first spring first end attachable to a first stopping member and the first spring second end configured to be attached to said boat trailer.

8. The kit of claim 6, further comprising a second stopping member attached to a second support member second surface between the second pivot and the second support member second end and extending away from the second support member first surface.

9. The kit of claim 8, further comprising a second spring having a second spring first end and a second spring second end, the second spring first end attachable to a second stopping member and the second spring second end configured to be attached to said boat trailer.

10. The kit of claim 5, further comprising a first connector attached to the first support member first surface between the first pivot and the first support member first end, the first connector configured to attach the first alignment member to the first support member.

11. The kit of claim 10, further comprising a second connector attached to the first support member first surface between the first pivot and the first support member second end, the second connector configured to attach the second alignment member to the first support member.

12. The kit of claim 11, further comprising a third connector attached to the second support member first surface between the second pivot and the second support member first end, the third connector configured to attach the third alignment member to the second support member.

13. The kit of claim 12, further comprising a fourth connector attached to the second support member first surface between the second pivot and the second support member second end, the fourth connector configured to attach the fourth alignment member to the second support member.

14. The kit of claim 13, wherein the first connector defines a first connector passageway;
further comprising a first fastener disposed in the first connector passageway, the first fastener configured to adjustably secure the first alignment member to the first support member.

15. The kit of claim 14, wherein the second connector defines a second connector passageway;
further comprising a second fastener disposed in the second connector passageway, the second fastener configured to adjustably secure the second alignment member to the first support member.

16. The kit of claim 15, wherein the third connector defines a third connector passageway;
further comprising a third fastener disposed in the third connector passageway, the third fastener configured to adjustably secure the third alignment member to the second support member.

17. The kit of claim 1, wherein the first pivot and the second pivot are configured to be connected to said trailer by a first bracket and a second bracket using U-bolts.

18. The kit of claim 1, further comprising a first shield disposed over the first alignment member second portion, a second shield disposed over the second alignment member second portion, a third shield disposed over the third alignment member second portion, and a fourth shield disposed over the fourth alignment member second portion.

19. A boat centering kit for attachment to a boat trailer, comprising:
a first support member having a first support member first end and a first support member second end;
a first pivot attachable to the first support member between the first support member first end and the first support member second end, the first pivot configured to be attached to said boat trailer;
a first alignment member attachable to the first support member between the first pivot and the first support member first end, the first alignment member having a first alignment member first portion and a first alignment member second portion, the first alignment member first portion extending from the first support member at a first alignment member first portion angle when the first alignment member is attached to the first support member, the first alignment member second portion extending from the first alignment member first portion at a first alignment member second portion angle relative to the first alignment member first portion;
a second alignment member attachable to the first support member between the first pivot and the first support member second end, the second alignment member having a second alignment member first portion and a second alignment member second portion, the second alignment member first portion extending from the first support member at a second alignment member first portion angle when the second alignment member is attached to the first support member, the second alignment member second portion extending from the second alignment member first portion at a second alignment member second portion angle relative to the second alignment member first portion;
a first stopping member attachable to the first support member between the first pivot and the first support member second end;
a first spring having a first spring first end and a first spring second end, the first spring first end attachable to a first stopping member, the first spring second end configured to be attached to said boat trailer;
a second support member having a second support member first end and a second support member second end;
a second pivot attachable to the second support member and disposed between the second support member first end and the second support member second end, the second pivot configured to be attached to said boat trailer;
a third alignment member attachable to the second support member between the second pivot and the second support member first end, the third alignment member having a third alignment member first portion and a third alignment member second portion, the third alignment member first portion extending from the second support member at a third alignment member first portion angle when the third alignment member is attached to the second support member, the third alignment member second portion extending from the third alignment member first portion at a third alignment member second portion angle relative to the third alignment member first portion;
a fourth alignment member attachable to the second support member between the second pivot and the second support member second end, the fourth alignment member having a fourth alignment member first portion and a fourth alignment member second portion, the fourth alignment member first portion extending from the second support member at a fourth alignment member first portion angle when the fourth alignment member is attached to the second support member, the fourth alignment member second portion extending from the fourth alignment member first portion at a fourth alignment member second portion angle relative to the fourth alignment member first portion;
a second stopping member attachable to the second support member between the second pivot and the second support member second end;
a second spring having a second spring first end and a second spring second end, the second spring first end attachable to a second stopping member, the second spring second end configured to be attached to said boat trailer;
a first shield disposed over the first alignment member second portion;
a second shield disposed over the second alignment member second portion;
a third shield disposed over the third alignment member second portion; and
a fourth shield disposed over the fourth alignment member second portion.

20. A boat centering system, comprising:
a boat trailer;
a first support member having a first support member first end and a first support member second end;
a first pivot attached to the first support member between the first support member first end and the first support member second end, the first pivot attached to the boat trailer;
a first alignment member attached to the first support member between the first pivot and the first support member first end, the first alignment member having a first alignment member first portion and a first alignment member second portion, the first alignment member first portion extending from the first support member at a first alignment member first portion angle, the first alignment member second portion extending from the first alignment member first portion at a first alignment member second portion angle relative to the first alignment member first portion;
a second alignment member attached to the first support member between the first pivot and the first support member second end, the second alignment member having a second alignment member first portion and a second alignment member second portion, the second alignment member first portion extending from the first support member at a second alignment member first portion angle, the second alignment member second portion extending from the second alignment member first portion at a second alignment member second portion angle relative to the second alignment member first portion;
a second support member having a second support member first end and a second support member second end;
a second pivot attached to the second support member and disposed between the second support member first end and the second support member second end, the second pivot attached to the boat trailer;
a third alignment member attached to the second support member between the second pivot and the second support member first end, the third alignment member having a third alignment member first portion and a third alignment member second portion, the third alignment member first portion extending from the second support member at a third alignment member first portion angle, the third alignment member second portion extending from the third alignment member first portion at a third alignment member second portion angle relative to the third alignment member first portion; and
a fourth alignment member attached to the second support member between the second pivot and the second support member second end, the fourth alignment member having a fourth alignment member first portion and a fourth alignment member second portion, the fourth alignment member first portion extending from the second support member at a fourth alignment member first portion angle, the fourth alignment member second portion extending from the fourth alignment member first portion at a fourth alignment member second portion angle relative to the fourth alignment member first portion;
wherein each of the first alignment member first portion angle, the first alignment member second portion angle, the second alignment member first portion angle, the second alignment member second portion angle, the third alignment member first portion angle, the third alignment member second portion angle, the fourth alignment member first portion angle, and the fourth alignment member second portion angle are greater than 45 degrees.
